(19) United States
(12) Patent Application Publication
(10) Pub. No.: US 2008/0164990 A1
(43) Pub. Date: Jul. 10, 2008

(54) Apparatus and Method for Automobile Child Seat Alarms

(76) Inventor: Monte S. Anderson, Mansfield, TX (US)

Correspondence Address: Matthew S. Anderson, 12770 Coit Road Suite 600, Dallas, TX, 75251, US

(21) Appl. No.: 11/968,011

(22) Filed: Dec. 31, 2007

Related U.S. Application Data
(60) Provisional application No. 60/878,879, filed on Jan. 5, 2007.

(51) Int. Cl. B60Q 1/00

(52) U.S. Cl. 340/457

(57) ABSTRACT

An apparatus includes a first wireless transmitter configured to transmit a first wireless signal when the first wireless transmitter detects the presence of a child in a child seat. The apparatus also includes a second wireless transmitter configured to transmit a second wireless signal when the second wireless transmitter detects the presence of the child seat in an automobile. The apparatus also includes a module configured to activate an alert when a door of the automobile is ajar and the module receives both the first and second wireless signals.

### CROSS REFERENCE TO RELATED APPLICATION

This application claims priority to U.S. Provisional Patent Application 60/878,879, filed Jan. 5, 2007, hereby incorporated by reference in its entirety.

### TECHNICAL FIELD

The present disclosure is directed, in general, to child safety, and in particular to automobile child seats.

### BACKGROUND OF THE DISCLOSURE

There is a growing problem each year with infants and other young children being forgotten and left in an unoccupied and unattended car. In times of extreme heat or cold, this often leads to severe injury or the death of the child. Commonly, the driver later states that he or she had simply forgotten there was a child in the car.

There is, therefore, a need in the art for an apparatus and method for an improved child seat system.

### SUMMARY OF THE DISCLOSURE

There is disclosed various embodiments of an automobile child seat alarm system to alert a driver when a child is left in an automobile child seat.

According to one embodiment, an apparatus includes a first wireless transmitter configured to transmit a first wireless signal when the first wireless transmitter detects the presence of a child in a child seat. The apparatus also includes a second wireless transmitter configured to transmit a second wireless signal when the second wireless transmitter detects the presence of the child seat in an automobile. The apparatus also includes a module configured to produce an alert when a door of the automobile is ajar and the module receives both the first and second wireless signals.

According to another embodiment, an apparatus includes a wireless transmitter configured to transmit a wireless signal when the wireless transmitter detects the presence of a child in a child seat and the presence of the child seat in an automobile. The apparatus also includes a module configured to produce an alert when a door of the automobile is ajar and the module receives the wireless signal.

According to another embodiment, a method includes receiving a first wireless signal indicating the presence of a child in a child seat. The method also includes receiving a second wireless signal indicating the presence of the child seat in an automobile. The method also includes detecting when a door of the automobile is ajar. The method also includes producing an alert when the detecting, receiving the first wireless signal, and receiving the second wireless signal occur simultaneously.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 depicts a child seat and base according to one disclosed embodiment; and

FIG. 2 depicts an automobile including a system in accordance with a disclosed embodiment.

### DETAILED DESCRIPTION

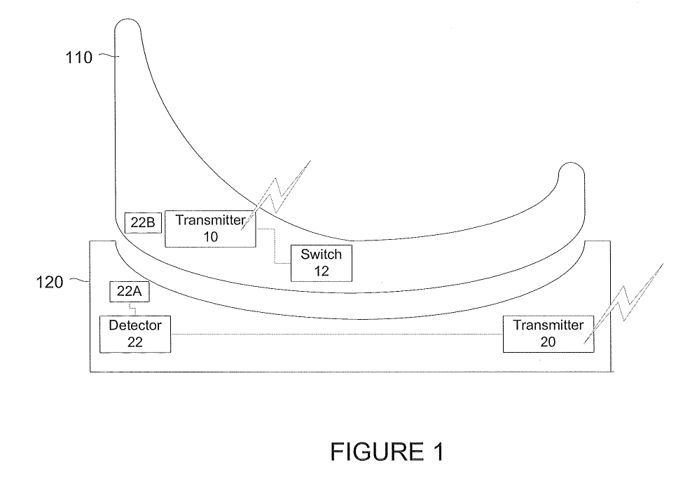

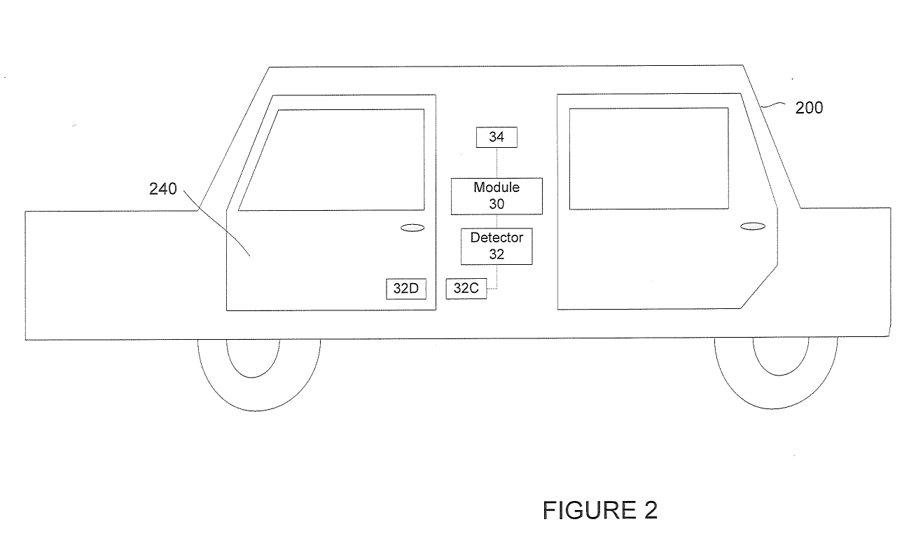

FIGS. 1-2, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

FIG. 1 depicts a child seat 110 and base 120 according to one disclosed embodiment of a wireless system that alerts the operator or passenger of an automobile 200 of the presence of a child in a child seat when the driver's door is opened. FIG. 2 depicts an automobile 200 including a system in accordance with a disclosed embodiment. Various embodiments accommodate removable baby/child seats. Actual structure and details of various car seats and bases are known to those of skill in the art, and are not depicted in the figures.

As used herein, “child seat” refers to any automobile front- or rear-facing child seating apparatus, whether an infant carrier, toddler seat, booster seat, or other, including both one-piece seats, and those seats that are removably installed into or attached to a child seat base that is itself removably attached to the automobile.

In one embodiment, a system uses two wireless transmitters and a receiver/alarm module. A first wireless transmitter 10 includes means for detecting the presence of a child in the child seat 110, such as a pressure/weight sensitive switch 12 that can be located, for example, inside or under a cushion of the child seat that is integral to, placed in, or attached to the child seat. Wireless transmitter 10 is configured to transmit a first wireless signal when the presence of a child in the child seat 110 is detected.

A second wireless transmitter 20 includes means for detecting when the child seat is installed in or attached to a child seat base. These means can include a simple electrical contact, a mechanical switch with appropriate electrical contacts, or other sensors as known to those of skill in the art, depicted generically as detector 22. In some embodiments, this includes two sensors, sensor 22A and sensor 22B. Sensor 22A attaches to the seat base; sensor 22B attaches to the child seat. Wireless transmitter 20, by detector 22, can detect when sensor 22A and sensor 22B are proximate to each other, and thereby determine that the child seat is installed in the child seat base. In some embodiments, the range can be adjusted so that the child seat need not be installed in the seat base, but is close enough to be determined as inside the car.

When wireless transmitter 20 detects that the child seat is installed in, attached to, or proximate to the seat base, as appropriate, or generally detects that the child seat in is the automobile, it transmits a second wireless signal indicating this.

In some embodiments, wireless transmitter 10 and wireless transmitter 20 can be implemented as a single transmitter installed in either the child seat or the base, where separate electrical inputs or switches are used to determine both that there is a child present in the child seat and the child seat is installed in the base. In some of these embodiments, the functions of wireless transmitter 10 and wireless transmitter 20 are therefore combined into a single transmitter, which can be regarded as either wireless transmitter 10 or wireless transmitter 20 as shown in FIG. 1.

A receiver/alarm module 30, as shown in FIG. 2, is capable of receiving the first and second wireless signals, and includes detection means for determining if the driver's door 240 (or optionally any door) of automobile 200 is ajar, shown generically as detector 32. Detector 32 can include a mechanical switch with appropriate electrical contacts, a circuit for detecting when the automobile's “open door” lighting circuit is activated, or include a sensor pair, such as sensor 32C and sensor 32D, that detect when the door is ajar. In this case, sensor 32C can be attached to the body of the vehicle, and sensor 32D can be attached to the door of the vehicle, and receiver/alarm module 30 detects when these sensors are separated to determine that the door is ajar.

Receiver/alarm module 30 also includes alerting means 34 for activating an audible or visual alert, or other alert, including but not limited to a buzzer, a speaker with a sound or speech generator, a light, a vibrator, or other alerting means as known to those of skill in the art. The alerting means may be located in the vehicle, outside the vehicle, or both, or can, for example, be integrated into a user's keychain. In alternate embodiments, the alerting means can also send a signal, using techniques known to those of skill in the art, that sends an electronic email or other message or signal to the driver or another designated person.

Receiver/alarm module 30 activates the alert when the first wireless signal is received from wireless transmitter 10 and the second wireless signal is received from wireless transmitter 20. Therefore an audible and/or visual alert is only activated, in this embodiment, when three conditions are met: a child is in the child seat; the child seat is in the seat base; and the driver's door is ajar. The alert may continue a selectable length of time after activation, even if the driver's door is then closed.

Another embodiment is useful in cases where a separate child seat base is not used, for example when using a child booster seat. In this case, wireless transmitter 20 is not needed or used, and so receiver/alarm module 30 is configured to be activated when only two conditions are met: a child is in the child seat; and the driver's door is ajar. A similar case is used when wireless transmitter 10 and wireless transmitter 20 are implemented as a single transmitter. In some embodiments, a configuration means, such a switch or other, can be used on receiver/alarm module 30 to indicate whether it should alert when both or only one wireless signal is received at a time when the door is ajar.

In some embodiments, wireless transmitter 10 and wireless transmitter 20 are integrated as a single wireless transmitter 10. In these embodiments, wireless transmitter includes both a means for detecting the presence of a child in the child seat, such as a pressure switch or other means known to those of skill in the art, and also includes means for detecting if the child seat is attached to the seat base, such as a switch that detects that the child seat and seat base are placed, pressed, or latched together. In these embodiments, wireless transmitter 10 will preferably transmit only when both detection means are activated.

Various embodiments allow for a child to remain in the child seat and be removed from the vehicle, and allow removing only the child from the vehicle, leaving the child seat in the child seat base. Many times when a child is young, a person will remove a child and the child seat from the vehicle (and seat base) while the child remains in the seat. This is often done to keep the child secure while locking the child seat into a grocery cart, a stroller, or another vehicle.

A system as disclosed herein can be easily uninstalled and reinstalled in another vehicle. Various embodiments do not require hard wiring to the vehicle, professional installation, or installation during the vehicle assembly.

In various embodiments, the wireless transmitters can include on/off switches, controls for selecting signal frequency, connections for external power, and otherwise, and are preferably battery-powered. The receiver/alarm module 30 can include an on/off switch, configuration controls for selecting signal frequency, selecting whether one or two wireless transmitters are being used, volume controls, and output selection controls for determining the type of alert. The receiver/alarm module 30 can be battery powered or connected to the automobile's electrical supply, as can the other various components described herein.

Those skilled in the art will recognize that, for simplicity and clarity, the full structure and operation of all systems and devices suitable for use with the present disclosure is not being depicted or described herein. Instead, only so much as is unique to the present disclosure or necessary for an understanding of the present disclosure is depicted and described. The remainder of the construction and operation of the devices and systems described may conform to any of the various current implementations and practices known in the art.

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope. Moreover, none of these claims are intended to invoke paragraph six of 35 USC §112 unless the exact words “means for” are followed by a participle.

What is claimed is:

1. An apparatus, comprising
a first wireless transmitter configured to transmit a first wireless signal when the first wireless transmitter detects the presence of a child in a child seat;
a second wireless transmitter configured to transmit a second wireless signal when the second wireless transmitter detects the presence of the child seat in an automobile; and
a module configured to activate an alert when a door of the automobile is ajar and the module receives both the first and second wireless signals.

2. The apparatus of claim 1, wherein the first wireless transmitter includes means for detecting the presence of a child in a child seat.

3. The apparatus of claim 1, wherein the first wireless transmitter includes a pressure sensitive switch for detecting the presence of a child in a child seat.

4. The apparatus of claim 3, wherein the pressure sensitive switch is located in a cushion of the child seat.

5. The apparatus of claim 1, wherein the first wireless transmitter is installed in the child seat.

6. The apparatus of claim 1, wherein the second wireless transmitter is installed in a child seat base that is attached to the automobile.

7. The apparatus of claim 1, wherein the second wireless transmitter includes means for detecting when the child seat is installed in a child seat base.

8. The apparatus of claim 1, wherein the second wireless transmitter includes a first sensor connected to the child seat and a second sensor connected to a child seat base, and wherein the second wireless transmitted is capable of detecting when the first sensor is proximate to the second sensor.

9. The apparatus of claim 1, wherein the module includes detection means for determining when a driver's door of the automobile is ajar.

10. The apparatus of claim 1, wherein the module includes a sensor pair that are attached to the automobile to determine when a door is ajar.

11. The apparatus of claim 1, wherein the module includes alerting means for activating an audible alert.

12. The apparatus of claim 11, wherein the module includes alerting means selected from the group consisting of a buzzer, a speaker with a sound generator, a speaker with a speech generator, a light, and a vibrator.

13. An apparatus, comprising
a wireless transmitter configured to transmit a wireless signal when the wireless transmitter detects the presence of a child in a child seat and the presence of the child seat in an automobile; and
a module configured to activate an alert when a door of the automobile is ajar and the module receives the wireless signal.

13. A method, comprising
receiving a first wireless signal indicating the presence of a child in a child seat;
receiving a second wireless signal indicating the presence of the child seat in an automobile;
detecting when a door of the automobile is ajar; and
activating an alert when the detecting, receiving the first wireless signal, and receiving the second wireless signal occur simultaneously.
